(19) United States
(12) Patent Application Publication
(10) Pub. No.: US 2025/0018595 A1
(43) Pub. Date: Jan. 16, 2025

(54) AUTOMATED ASSEMBLER

(71) Applicant: Merrick Machine Co., Alda, NE (US)

(72) Inventors: Russ Merrick, Alda, NE (US); Brad Pattison, Alda, NE (US); Darren Addy, Alda, NE (US); Mark Schwab, Alda, NE (US)

(21) Appl. No.: 18/770,220

(22) Filed: Jul. 11, 2024

Related U.S. Application Data
(60) Provisional application No. 63/526,070, filed on Jul. 11, 2023.

(51) Int. Cl. B27F 7/00; G06V 10/70

(52) U.S. Cl. CPC B27F 7/003; G06V 10/70

(57) ABSTRACT

An automated assembler may include an input feeder and an assembly sub-system configured to receive two or more pieces of input lumber from the input feeder. The assembly sub-system may include one or more sensors to generate sensor data associated with at least one of positions or orientations of the two or more pieces of input lumber, one or more guides configured to position at least some of the two or more pieces of input lumber in a selected orientation based on data from the one or more sensors, and one or more fastening tools configured to fasten the two or more pieces of input lumber to form an assembled product. The automated assembler may further include one or more output feed conveyors configured to receive the assembly sub-system.

### CROSS-REFERENCE TO RELATED APPLICATION

The present application claims the benefit under 35 U.S.C. § 119 (e) of U.S. Provisional Application Ser. No. 63/526,070, filed Jul. 11, 2023, naming RUSS MERRICK, BRAD PATTISON, DARREN ADDY, and MARK SCHWAB as inventors, which is incorporated herein by reference in the entirety.

### TECHNICAL FIELD

The present disclosure generally relates to machinery for producing products, and more specifically to automated assembly.

### BACKGROUND

Manufactured housing has a long history both in the United States and abroad. Wall panels or completed modules are built in factories and shipped to a site, where they may be erected into commercial or residential buildings. Often, wall panels employed for manufactured housing are formed of wood. Wood wall panels dominate this industry and the methodology for manufacture is well established. Additional parts and assemblies of the commercial or residential buildings may be pre-assembled and delivered to this area as subcomponents.

These subcomponents may be assembled by hand or by commercially available machines. Hand assembly of subcomponents provides the greatest flexibility, but hand assembly is normally to slow to deliver larger volumes of products. Machine assembly provides speed and quality. Subcomponent machines range in complexity from simple clamping and nailing fixtures to automated feed-through nailing machines. The common drawback of machines is the setup time necessary to convert from one style of subcomponent to the other. Thus, subcomponent machines are limited to batch building, stockpiling, and sorting.

### SUMMARY

In embodiments, the techniques described herein relate to an automated assembler, including an input feed conveyor; and an assembly sub-system configured to receive two or more pieces of input lumber from the input feed conveyor, where the assembly sub-system includes one or more sensors configured to generate sensor data associated with at least one of positions or orientations of the two or more pieces of input lumber; one or more guides configured to position at least some of the two or more pieces of input lumber in a selected orientation based on data from the one or more sensors; and one or more fastening tools configured to fasten the two or more pieces of input lumber to form an assembled product; one or more output feed conveyors configured to receive the assembled product.

In embodiments, the techniques described herein relate to an automated assembler, further including a controller including one or more processors configured to execute program instructions stored on a memory device, where the program instructions are configured to cause the one or more processors to identify the two or more pieces of input lumber based on the sensor data; determine a profile for forming the assembled product based on the identification of the two or more pieces of input lumber; and direct the one or more guides and the one or more fastening tools to form the assembled product according to the profile.

In embodiments, the techniques described herein relate to an automated assembler, where identify the two or more pieces of input lumber based on the sensor data includes identify the two or more pieces of input lumber based on the sensor data using a machine learning model.

In embodiments, the techniques described herein relate to an automated assembler, where the machine learning model is trained with training data using at least one of a supervised technique or a semi-supervised technique, where the training data includes training sensor data associated with known training components.

In embodiments, the techniques described herein relate to an automated assembler, where at least one of the one or more sensors includes a line sensor.

In embodiments, the techniques described herein relate to an automated assembler, where at least one of the one or more sensors includes a camera.

In embodiments, the techniques described herein relate to an automated assembler, where at least one of the one or more guides includes a stop.

In embodiments, the techniques described herein relate to an automated assembler, where at least one of the one or more guides includes one or more vertical rollers.

In embodiments, the techniques described herein relate to an automated assembler, where at least one of the one or more guides includes one or more horizontal rollers.

In embodiments, the techniques described herein relate to an automated assembler, where at least one of the one or more fastening tools includes one or more nail guns.

In embodiments, the techniques described herein relate to a method for automated assembly, including providing two or more pieces of input lumber to an assembly sub-system, where the assembly sub-system includes one or more sensors configured to generate sensor data associated with at least one of positions or orientations of the two or more pieces of input lumber; one or more guides configured to position at least some of the two or more pieces of input lumber in a selected orientation based on data from the one or more sensors; and one or more fastening tools configured to fasten the two or more pieces of input lumber; selecting a profile for fastening the input lumber to form an assembled product; and fastening the two or more pieces of input lumber with the one or more fastening tools using the profile to form the assembled product.

In embodiments, the techniques described herein relate to a method, where selecting a profile for fastening the assembled product includes receiving a selected profile from a user.

In embodiments, the techniques described herein relate to a method, where selecting a profile for fastening the assembled product includes predicting the profile based on the sensor data.

In embodiments, the techniques described herein relate to a method, where predicting the selected profile based on the sensor data includes identifying the two or more pieces of input lumber based on the sensor data; and determining the profile based on the identification of the two or more pieces of input lumber.

In embodiments, the techniques described herein relate to a method, where identifying the two or more pieces of input lumber based on the sensor data includes identifying the two or more pieces of input lumber based on the sensor data using a machine learning model.

In embodiments, the techniques described herein relate to a method, where the machine learning model is trained with training data using at least one of a supervised technique or a semi-supervised technique, where the training data includes training sensor data associated with known training components.

In embodiments, the techniques described herein relate to a method, where at least one of the one or more sensors includes at least one of a line sensor or a camera.

In embodiments, the techniques described herein relate to a method, where the one or more guides include at least one or more vertical rollers or one or more horizontal rollers.

In embodiments, the techniques described herein relate to a method, where at least one of the one or more fastening tools includes one or more nail guns.

In embodiments, the techniques described herein relate to a method, further including securing the two or more pieces of input lumber with the one or more guides based on the profile prior to fastening the two or more pieces of input lumber with the one or more fastening tools to form the assembled product.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a block diagram of an automated assembler, in accordance with one or more embodiments of the present disclosure.

FIG. 1B illustrates a perspective view of a schematic of an automated assembler, in accordance with one or more embodiments of the present disclosure.

FIG. 1C illustrates a first side perspective view of one design an assembly sub-system, in accordance with one or more embodiments of the present disclosure.

FIGS. 2A-2B illustrate perspective views of an alternative design of the vertical clamp rollers shown in FIG. 1C, in accordance with one or more embodiments of the present disclosure.

FIG. 3 illustrates a side perspective view of an automated assembler with an alternative design of a square stop, in accordance with one or more embodiments of the present disclosure.

FIG. 4 illustrates a schematic diagram of a narrowband illumination source coupled to a camera sensor for characterizing the input lumber, in accordance with one or more embodiments of the present disclosure.

FIG. 5 illustrates a side perspective view of the assembly sub-system depicting a shock pad to absorb recoil from a nail gun fastening tool, in accordance with one or more embodiments of the present disclosure.

FIG. 6 illustrates a side perspective view of the assembly sub-system depicting an overhead tool support suitable for securing components such as, but not limited to, magazines for the fastening tools with a flexible linkage.

FIG. 7 illustrates non-limiting examples of different types of assembled products, in accordance with one or more embodiments of the present disclosure.

FIG. 8 illustrates a flow diagram for automated assembly, in accordance with one or more embodiments of the present disclosure.

FIG. 9 illustrates a flow diagram depicting one implementation of the method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing automated assembly of lumber components, which may be, but are not required to be, subcomponents suitable for use in residential or commercial construction. The term assembled product is used herein to refer to a product that may be automatically assembled based on supplied lumber components. For example, systems and methods disclosed herein may provide automated assembly of wood or composite lumber products into selected configurations such as, but not limited to, headers, els, double els, trimmers, corner or stud packs, or tees. The assembled product may then be used in construction products as needed.

Some embodiments of the present disclosure are directed to an automated assembler that may receive various input lumber components and fasten these input lumber components into a desired assembled product. For example, the automated assembler may receive pre-cut lumber, position and/or clamp this received lumber as needed, and fasten the pre-cut lumber (e.g., via nails, screws or any suitable fastener) into an assembled component with a selected fastening profile (e.g., an arrangement of locations for fasteners to produce a selected type of assembled component.

The automated assembler may include various sensors such as, but not limited to, one or more cameras, one or more optical sensors (e.g., line sensors, or the like), or one or more mechanical sensors. These sensors may be used for a variety of purposes. In some embodiments, sensors are used to identify various properties of input lumber components to be assembled such as, but not limited to, the type, size, or orientation of received input lumber components. In some embodiments, sensors are used to identify whether input lumber components are properly positioned within the automated assembler for fastening into a desired assembled product. In some embodiments, sensors are used to identify and/or diagnose anomalies in a fabrication process.

In some embodiments, an automated assembler may selectively fabricate multiple types of assembled products (e.g., headers, els, double els, trimmers, corner or stud packs, tees, or the like). In this case, the desired type of assembled product may be selected using any of various techniques. For example, the automated assembler may include a user interface through which a user may select a desired type of assembled product. As another example, the automated assembler may identify a type of assembled product based on received input lumber components. As an illustration, the automated assembler may utilize sensor data to analyze received input lumber components (e.g., types, sizes, orientations, or the like) and determine a type of assembled product based on this sensor data. Further, the automated assembler may optionally present a selected type of assembled product to a user for verification (e.g., with the user interface).

In some embodiments, the automated assembler incorporates one or more machine learning models to provide automated fabrication. For example, one or more machine learning models may provide object detection for the analysis of received input lumber components to be fabricated. As another example, one or more machine learning models may be used to identify anomalies during the fabrication process (e.g., associated with improper placement of the input lumber components, or the like) and either generate alerts or control various system components to alleviate the anomalies. In this way, the machine learning models may improve the quality and/or efficiency of automated fabrication.

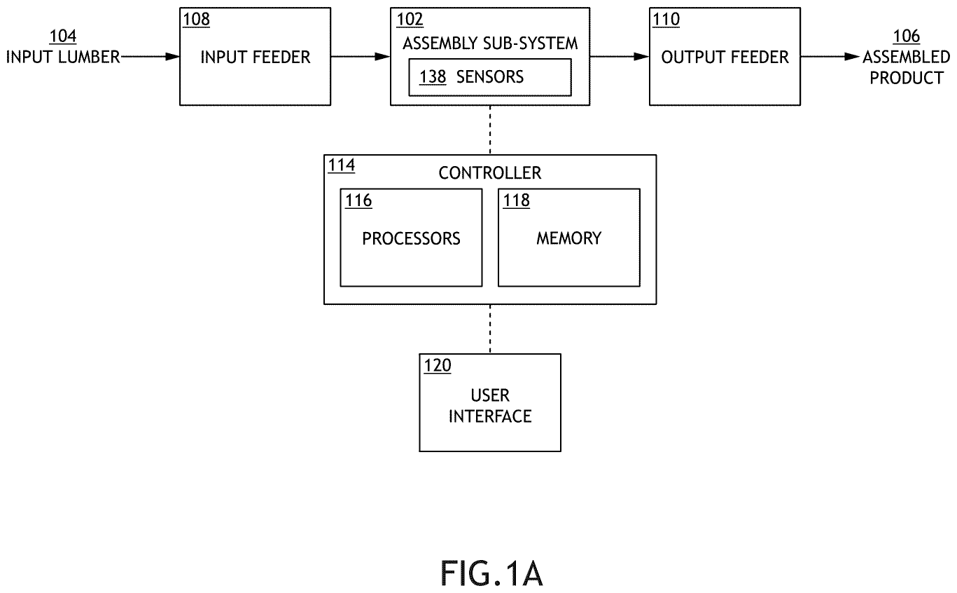

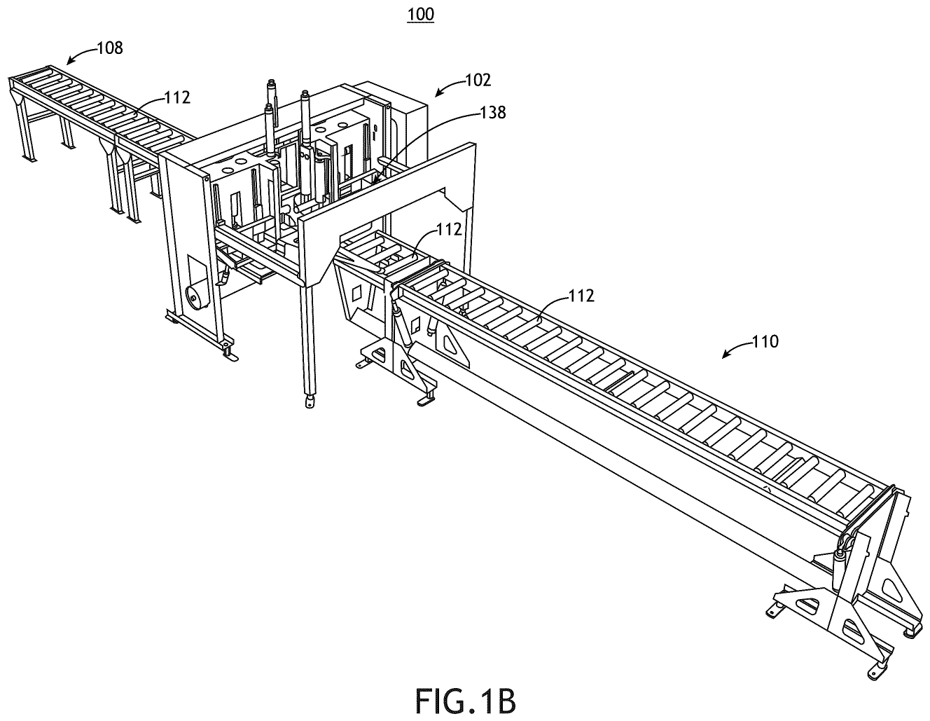

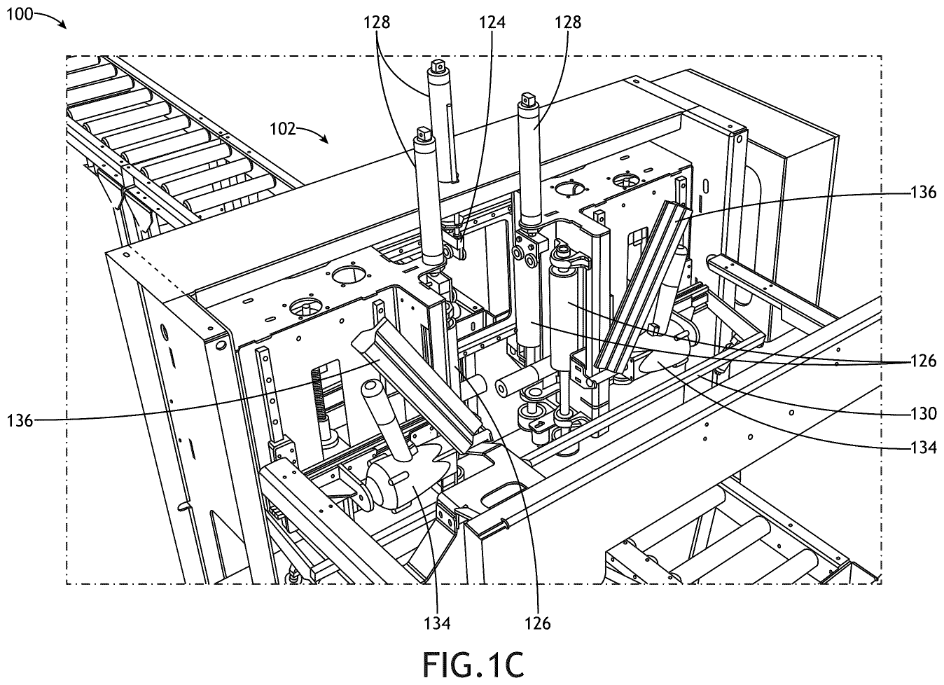

Referring now to FIGS. 1A-9, systems and methods for automated fabrication are described in greater detail, in accordance with one or more embodiments of the present disclosure.

FIG. 1A illustrates a block diagram of an automated assembler 100, in accordance with one or more embodiments of the present disclosure. FIG. 1B illustrates a perspective view of a schematic of an automated assembler 100, in accordance with one or more embodiments of the present disclosure.

In some embodiments, the automated assembler 100 includes an assembly sub-system 102 configured to secure and fasten input lumber 104 into an assembled product 106. The automated assembler 100 may further include an input feeder 108 to feed the input lumber 104 to the assembly sub-system 102 and/or an output feeder 110 to receive the assembled product 106. The input feeder 108 and/or the output feeder 110 may include any number or type of machinery suitable for transporting input lumber 104 and/or assembled products 106 such as, but not limited to, conveyor belts or rollers. For example, FIG. 1B depicts an input feeder 108 and an output feeder 110 as conveyor systems with rollers 112 that may be powered or unpowered.

The input feeder 108 may be provided to arrange the input lumber 104. It is contemplated that the area of the input feeder 108 may allow viewing of the input materials by one or more sensor(s) or camera(s) or other shape detection device as described in greater detail herein.

It is contemplated that the automated assembler 100 may be operable with standard dimensional lumber profiles (e.g. 2 inch by 4 inch lumber, 2 inch by 6 inch lumber, and the like). Additionally, it is contemplated that the automated assembler 100 may accommodate and automatically detect a variety of lengths of finished subcomponents.

The output feeder 110 may include an area to receive the finished assembled product 106. The assembled product 106 may be directed automatically to one or more pre-programmed staging areas. FIG. 1B depicts an output feeder 110 with a single staging area, though this is merely an illustration and not a limitation. An output feeder 110 providing multiple staging areas may incorporate any components suitable for selectively directing the assembled products 106 such as, but not limited to, directional conveyors, mechanical diverters, indexing material, and/or mechanical gates. Further, assembled products 106 may be directed to different staging areas of an output feeder 110 based on any criteria. In some embodiments, assembled products 106 are sorted into different staging areas based on type (e.g., headers, els, double els, trimmers, corner or stud packs, tees, or the like).

In some embodiments, the automated assembler 100 includes a controller 114, which may include one or more processors 116 configured to execute program instructions stored on memory 118 (e.g., a memory device).

The controller 114 may be configured to perform one or more functions of the automated assembler 100 such as, but not limited to, object detection, sensing, or directing (e.g., via control signals) any components of the assembly sub-system 102. For example, the controller may be configured to integrate camera(s), lighting, a machine learning engine, a user interface, a network communication, sensors, power distribution, circuit protection, prime movers, control logic, an emergency stop, and the like.

It is contemplated that the processors 116 may include any type of processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the processors 116 may include any device configured to execute algorithms and/or instructions (e.g., program instructions stored in memory 118). In one embodiment, the processors 116 may be embodied as a desktop computer, mainframe computer system, workstation, image computer, parallel processor, networked computer, or any other computer system configured to execute a program configured to operate or operate in conjunction with the system, as described throughout the present disclosure. Moreover, different subsystems of the system may include a processor or logic elements suitable for carrying out at least a portion of the steps described in the present disclosure. Therefore, the above description should not be interpreted as a limitation on the embodiments of the present disclosure but merely as an illustration.

The memory 118 may include a tangible, computer-readable storage medium that provides storage functionality to store various data and/or program code associated with operation of the controller 114 and/or other adapter components, such as software programs and/or code segments, or other data to instruct the controller 114, processors 116, and/or other elements to perform (e.g., cause the processors 116 to perform) the functionality described herein. Thus, the memory 118 can store data, such as a program of instructions for operating the automated assembler 100. It should be noted that while a single memory is described, a wide variety of types and combinations of memory (e.g., tangible, non-transitory memory) can be employed. The memory 118 may be integral with the controller, can comprise stand-alone memory, or can be a combination of both. Some examples of the memory can include removable and non-removable memory components, such as random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

The controller 114 may further include a communication interface. The communication interface may be operatively configured to communicate with components of the controller 114 and other components of the automated component assembler. For example, the communication interface can be configured to retrieve data from the controller 114 or other automated assembler 100 components, transmit data for storage in the memory, retrieve data from storage in the memory, and so forth. The communication interface can also be communicatively coupled with controller and/or automated component assembler elements to facilitate data transfer between automated assembler 100 components.

In some embodiments, the controller 114 may implement one or more machine learning models. Any type of machine learning model may be implemented including, but not limited to, unsupervised models, supervised models, or semi-supervised models. For example, an unsupervised machine learning model may identify one or more patterns in input data without requiring labels. As another example, supervised or semi-supervised machine learning models may be trained on labeled training data. In this way, such models may assign labels to new data based on trained correlations. As described in greater detail below, such models are well suited for, but not limited to, object identification.

In some embodiments, the automated assembler 100 includes a user interface 120. The user interface 120 may include any number or type of components suitable for providing information to a user in any format (e.g., a visual format, an audio format, or a tactile format). For example, the user interface 120 may include one or more displays, speakers, or haptic feedback devices. The user interface 120 may further include any number or type of components to receive information from a user. For example, the user interface 120 may include a touchscreen, a trackpad, a mouse, a microphone, buttons, or mechanical input devices.

The assembly sub-system 102 may include any number or types of machinery suitable for securing and/or fastening the input lumber 104 into an assembled product 106. FIG. 1C illustrates a first side perspective view of one design an assembly sub-system 102, in accordance with one or more embodiments of the present disclosure.

In some embodiments, the assembly sub-system 102 includes one or more components to facilitate motion of the input lumber 104 such as, but not limited to, conveyor belts or rollers. For example, FIGS. 1B and 1C depict rollers 112 within the assembly sub-system 102 to facilitate movement of the input lumber 104.

In some embodiments, the assembly sub-system 102 includes one or more guides to constrain motion of the input lumber 104, where the guides may be fixed or positionable. The guides may include any type or combination of components suitable for positioning one or more pieces of input lumber 104 into a configuration suitable for fastening to form a selected assembled product 106. For example, guides may include rollers, rails, or the like. Further, guides may optionally function as clamps to secure the input lumber 104 prior to and/or during fastening.

For example, FIG. 1C depicts vertical clamp rollers 124 as well as horizontal clamp rollers 126 that may be positioned to come into contact with one or more pieces of input lumber 104 from various sides. In particular, the vertical clamp rollers 124 and the input lumber 104 are shown as being connected to air cylinder rods 128 as positioning mechanisms. However, this is merely illustrative and should not be interpreted as limiting the scope of the present disclosure. Rather, the automated assembler 100 may include any type of fixed or positionable guides, where positionable guides may be positioned using any mechanism known in the art.

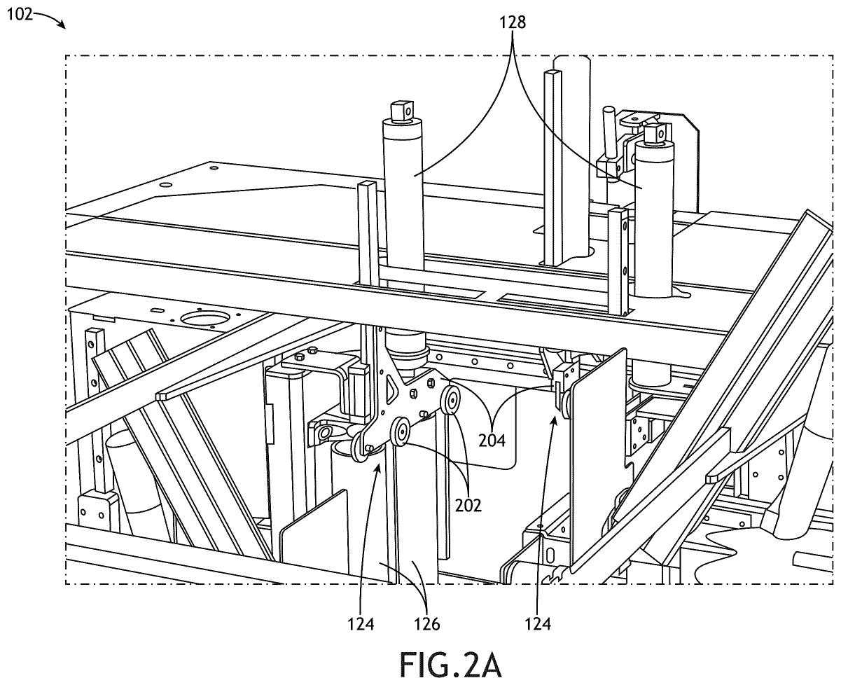

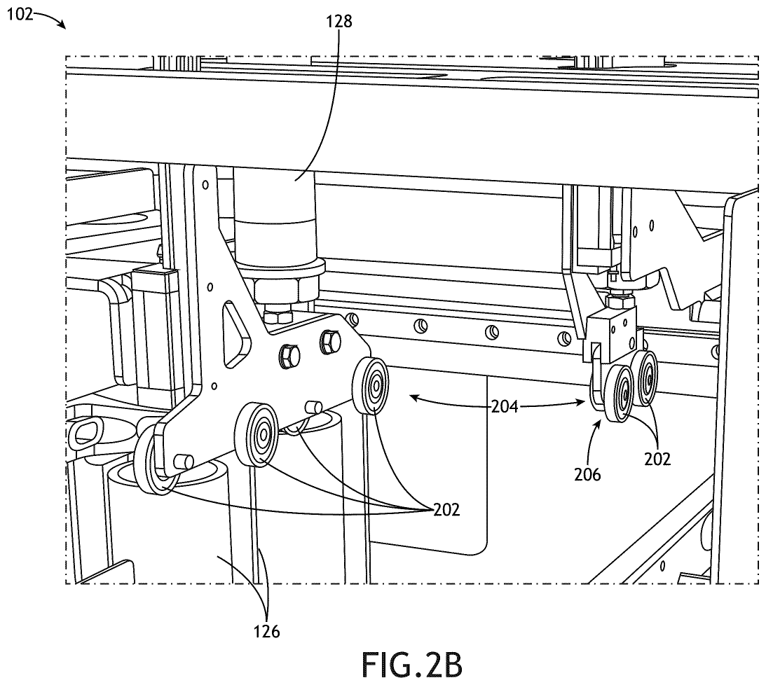

FIGS. 2A-2B illustrate perspective views of an alternative design of the vertical clamp rollers 124 shown in FIG. 1C, in accordance with one or more embodiments of the present disclosure. In particular, FIGS. 2A-2B depict vertical clamp rollers 124 with rows of roller wheels 202 on a reinforced guide 204. For example, the of the reinforced guide 204 may provide sufficient strength to prevent twisting and bending during guiding.

FIG. 2B further depicts a configuration in which one or more clamps are actuatable, which may help distribute clamping force. In particular, a center clamp 206 in FIG. 2B may articulate several degrees (e.g., +/−3 degrees).

In some embodiments, the assembly sub-system 102 includes one or more stops 130 to position any of the pieces of input lumber 104 together or individually. For example, the assembly sub-system 102 may include a square stop 130 to align ends of the input lumber 104 to be flush with each other.

Any of the stops 130 may be retractable to allow for selective use. As an illustration, FIG. 1C depicts a square stop 130 in a retracted position such that it may not come into contact with the input lumber 104. Such a square stop 130 may be adjusted to an engaged position to align the input lumber 104 prior to fastening and may retract after fastening to allow the assembled product 106 to propagate through the automated assembler 100.

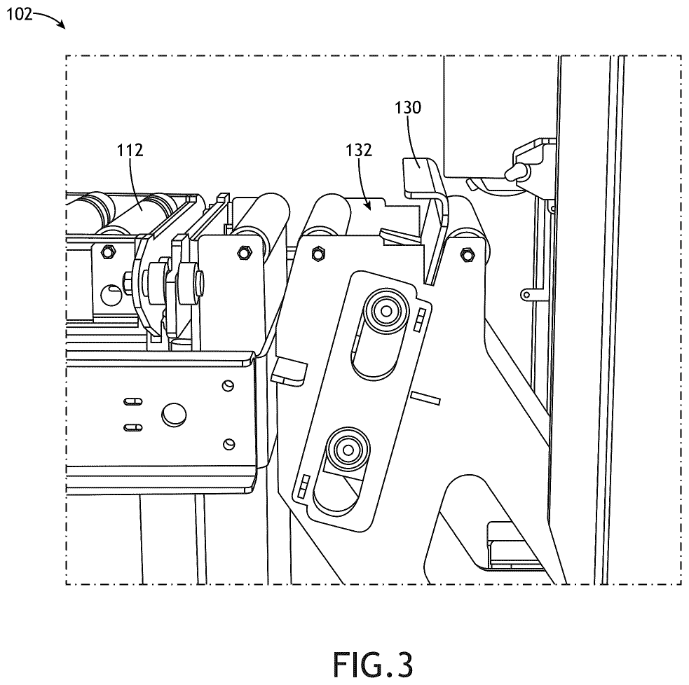

FIG. 3 illustrates a side perspective view of an automated assembler 100 with an alternative design of a square stop 130, in accordance with one or more embodiments of the present disclosure. Further, FIG. 3 depicts the square stop 130 in an engaged position suitable for coming into contact with the input lumber 104. Although not explicitly shown, this square stop 130 may retract into an opening 132 to allow an assembled product 106 to pass through to the output feeder 110. In this configuration, the square stop 130 is self-contained within the automated assembler 100 and only spans a width of the rollers 122. It is contemplated that limiting a size of the square stop 130 may beneficially provide space for additional components of the assembly sub-system 102 such as a supporting member to support a start end of the input lumber 104, which may allow accurate alignment even when some of the input lumber 104 are bowed and/or warped.

In some embodiments, the assembly sub-system 102 includes one or more fastening tools 134 to fasten the input lumber 104 together to form an assembled product 106.

The one or more fastening tools 134 may include any type of tool known in the art suitable for fastening lumber such as, but not limited to, a nail gun, an automated screwdriver, an automated bolt fastener, or a glue applicator. As an illustration, FIG. 1C depicts fastening tools 134 as nail guns on either side of the rollers 112 for fastening input lumber 104 from multiple sides to form an assembled product 106. In some embodiments, the assembly sub-system 102 includes multiple types of fastening tools 134. For example, the assembly sub-system 102 may include a drill to drill pilot holes in the input lumber 104 and an automated screwdriver or bolt fastener to insert fasteners in the pilot holes. As another example, the assembly sub-system 102 may apply glue to one or more components before fastening with other fasteners.

The one or more fastening tools 134 may be adjustable to fasten the input lumber 104 at different locations. As an illustration, FIG. 1C depicts the fastening tools 134 on adjustable mounts 136 (e.g., 2-axis or 3-axis rails, stages, or the like). In this way, the height of the fastening tools 134 may be adjusted on the mounts 136 to allow for fastening at different heights, locations, and/or angles. Further, the distribution of fastener positions may be programmable.

In some embodiments, the assembly sub-system 102 includes one or more sensors 138.

The sensors 138 may include any type of device suitable for characterizing the assembly sub-system 102 alone, the input lumber 104 alone, and/or the relationship between the input lumber 104 and the assembly sub-system 102. For example, the sensors 138 may include one or more cameras suitable for generating sensor data in the form of images and/or video.

As an illustration, FIG. 1B depicts a camera sensor 138 oriented to view the input lumber 104 as well as surrounding components of the assembly sub-system 102 (e.g., vertical clamp rollers 124, horizontal clamp rollers 126, fastening tools 134, or the like) from a perspective view. It is contemplated herein that a camera sensor 138 may be well suited for, but is not limited to, object detection (e.g., detecting a number, size, or orientation of pieces of input lumber 104, detecting positions of components of the assembly sub-system 102, or the like).

In some embodiments, the assembly sub-system 102 includes one or more illumination sources 402 to illuminate the input lumber 104 and/or an operational area of the assembly sub-system 102 with illumination 404 of any spectral content. For example, an illumination source 402 may include a broadband illumination source (e.g., a light emitting diode (LED), an incandescent light source, a lamp source, or the like), which may be suitable for, but not limited to, color imaging with a camera sensor 138. As another example, an illumination source 402 may include a narrowband illumination source (e.g., a laser source, or the like), which may be suitable for marking and/or sensing.

In some embodiments, an assembly sub-system 102 may utilize a narrowband illumination source 402 to project a line of narrowband illumination (e.g., a green laser source to project a green laser line) onto the input lumber 104 coupled with a camera sensor 138 to characterize various aspects of the input lumber 104.

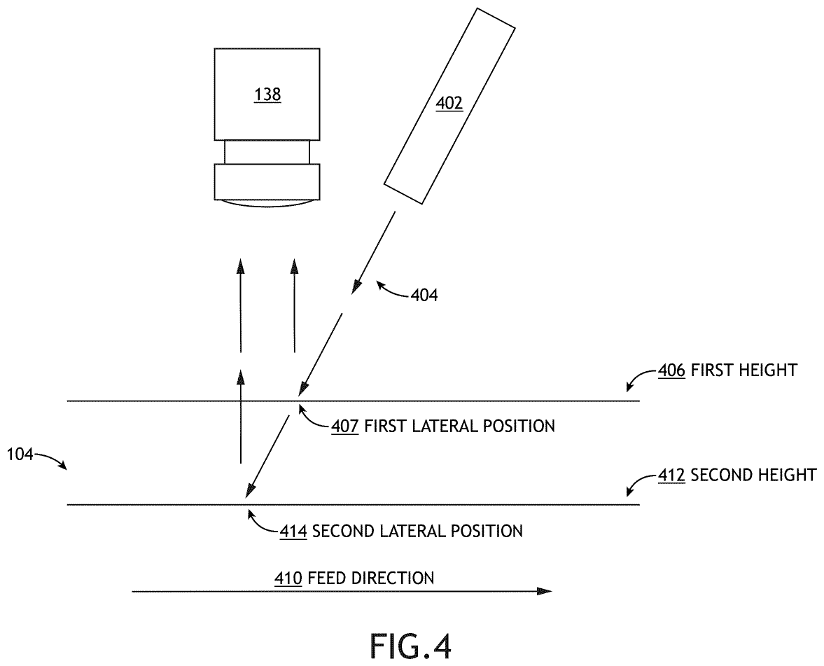

FIG. 4 illustrates a schematic diagram of a narrowband illumination source 402 coupled to a camera sensor 138 for characterizing the input lumber 104, in accordance with one or more embodiments of the present disclosure. In some embodiments, the narrowband illumination source 402 projects a line of illumination oriented orthogonal to a feed direction of the input lumber 104 through the assembly sub-system 102 (and out of the plane of the image), where the camera sensor 138 is oriented to view the illumination. In this configuration, variations in height of the input lumber 104 (e.g., associated with an end of board, knots, or other defects) may result in deviations of a perceived position of the line of illumination. For instance, input lumber 104 with a first height 406 may reflect incident illumination 404 at a first lateral position 408 along a feed direction 410, whereas input lumber 104 with a second height 412 (or a lack of input lumber 104) may result in the reflection of incident illumination 404 at a second lateral position 414 along the feed direction 410.

As an illustration, a “snapshot” of the input lumber 104 may be taken after clamping and before feeding in order to generate a baseline image. For example, additional images of the input lumber 104 may be compared to the baseline image to determine variations.

The position of the laser line as the input lumber 104 progress through the automated assembler 100 may then be determined using any suitable technique. For instance, a machine learning technique (e.g., an artificial intelligence technique) may be utilized to identify a position of the line, even in the present of scattering due to wood grain and the like.

Variations of the position of the line may then be attributed to various characteristics of the input lumber 104. For instance, when an anomaly is detected, its position is recorded. If the anomaly persists after a brief period, it may be validated as an end of board position. If the original image returns, a surface irregularity (e.g., a knot or other defect) may be identified.

Such an arrangement may generally provide both height and width measurements of the input lumber 104 as well as topographical profile of the input lumber 104.

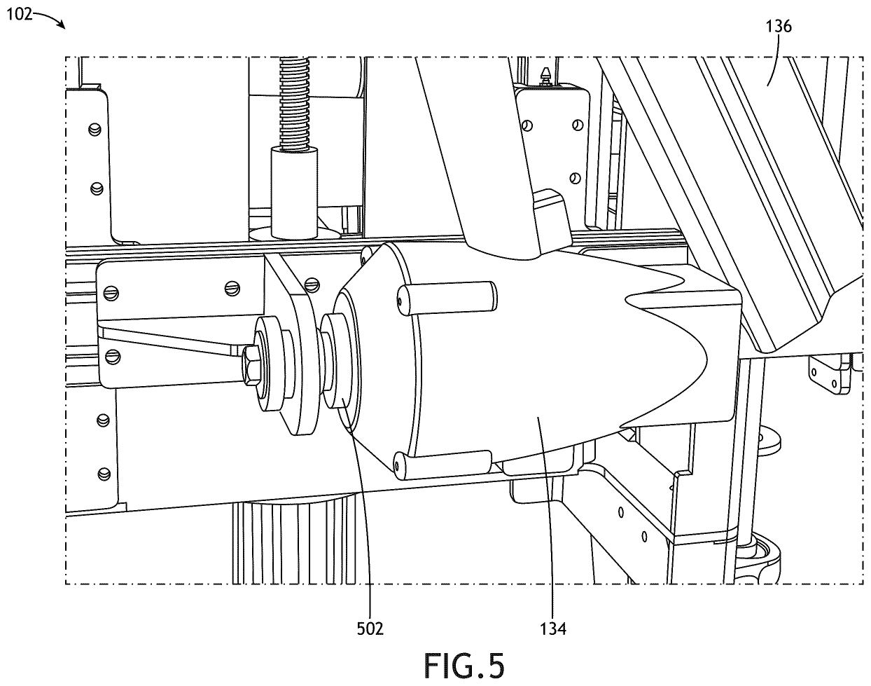

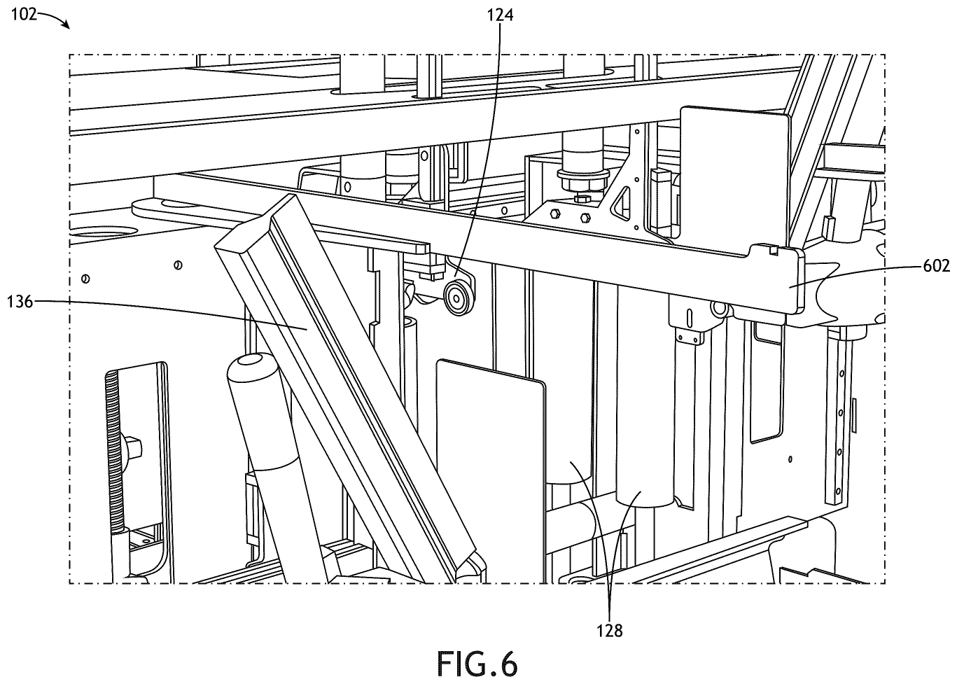

Referring now to FIGS. 5-6, additional aspects of the assembly sub-system 102 are described in greater detail, in accordance with one or more embodiments of the present disclosure.

In some embodiments, the assembly sub-system 102 includes shock absorbers to mitigate shock induced by the fastening tools 134 or other components, which may impact the precision and/or robustness of data generated by the sensors 138. For example, the assembly sub-system 102 may include shock pads (e.g., rubber shock pads) to absorb recoil from fastening tools 134 such as nail guns. FIG. 5 illustrates a side perspective view of the assembly sub-system 102 depicting a shock pad 502 to absorb recoil from a nail gun fastening tool 134, in accordance with one or more embodiments of the present disclosure.

In some embodiments, the assembly sub-system 102 includes one or more overhead tool supports to support various components such as, but not limited to, magazines for fastening tools 134. For example, such magazines may be relatively heavy and could potentially stress a carriage system for positioning the fastening tools 134. By supporting the weight of the magazines with a flexible linkage (e.g., a chain, or the like), mounts for the fastening tools 134 only need to support (or substantially support) the weight of the fastening tools 134 themselves and not the magazine. FIG. 6 illustrates a side perspective view of the assembly sub-system 102 depicting an overhead tool support 602 suitable for securing components such as, but not limited to, magazines for the fastening tools 134 with a flexible linkage.

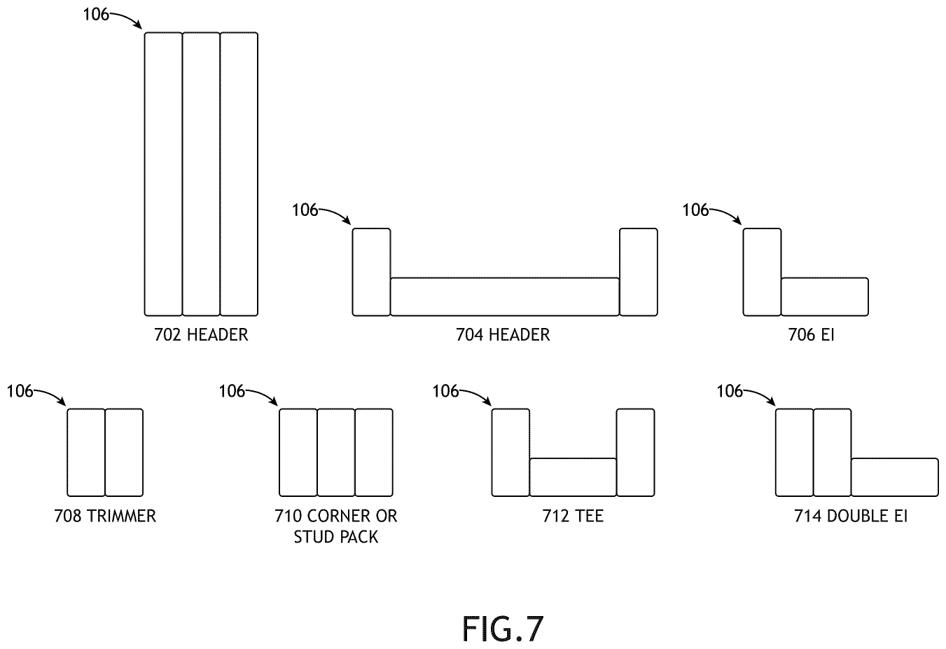

Referring now to FIGS. 7-9, the operation of the automated assembler 100 is described in greater detail, in accordance with one or more embodiments of the present disclosure.

It is contemplated herein that the automated assembler 100 may operate with various levels of interaction with a user (e.g., an operator).

In a general sense, the automated assembler 100 may support automated fabrication of multiple types of assembled products 106. As an illustration, FIG. 7 illustrates non-limiting examples of different types of assembled products 106, in accordance with one or more embodiments of the present disclosure. In particular, FIG. 7 depicts a first header 702, a second header 704, an el 706, a trimmer 708, a corner or stud pack 710, a tee 712, and a double el 714.

In some embodiments, the user may manually select the type of assembled product 106 through the user interface 120. In this configuration, the assembly sub-system 102 may position, clamp, and fasten the input lumber 104 based on the selected type of assembled product 106. Further, the automated assembler 100 may utilize data from one or more sensors 138 to determine whether the input lumber 104 are properly positioned prior to fastening. In a case where an anomaly is detected, the user may be alerted prior to fastening. As a result, the automated assembler 100 may efficiently guide the user and provide quality control.

In some embodiments, the automated assembler 100 identifies or predicts the type of assembled product 106 based on the number, type, and/or orientation of the input lumber 104. For example, automated assembler 100 may include one or more camera sensors 138 to capture images of the input lumber 104 prior to fastening and the controller 114 may implement object detection based on images generated by the camera sensors 138. Further such object detection may be, but is not required to be, implemented using machine learning models. As an illustration, a machine learning model may be trained (e.g., using supervised learning, semi-supervised learning, or any other suitable technique) based on images of known input lumber 104 arranged in configurations suitable for known assembled products 106.

In some cases, the controller 114 may provide a predicted type of assembled product 106 to a user for verification (e.g., with the user interface 120) prior to fastening. Such a configuration may ensure safety and/or be used to continually train the machine learning model.

In some cases, the controller 114 automatically fastens the input lumber 104 to form the predicted type of assembled product 106. Such a configuration may provide fully automated operation and may be suitable for situations in which the model has been sufficiently trained to provide errors within an allowable tolerance.

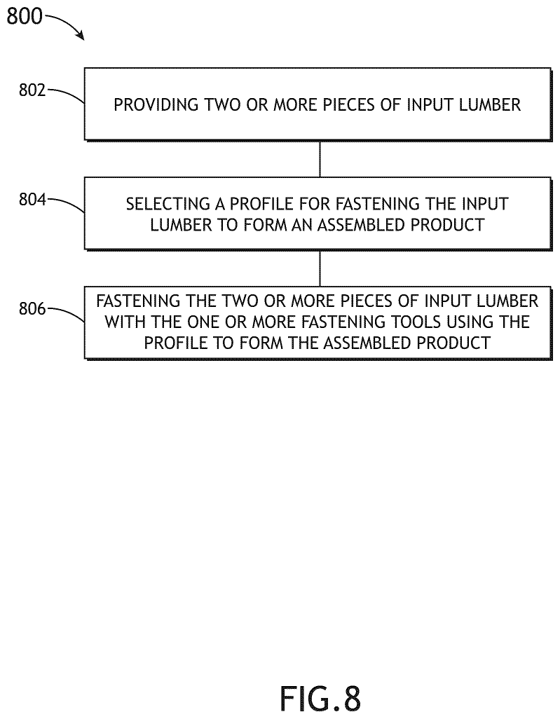

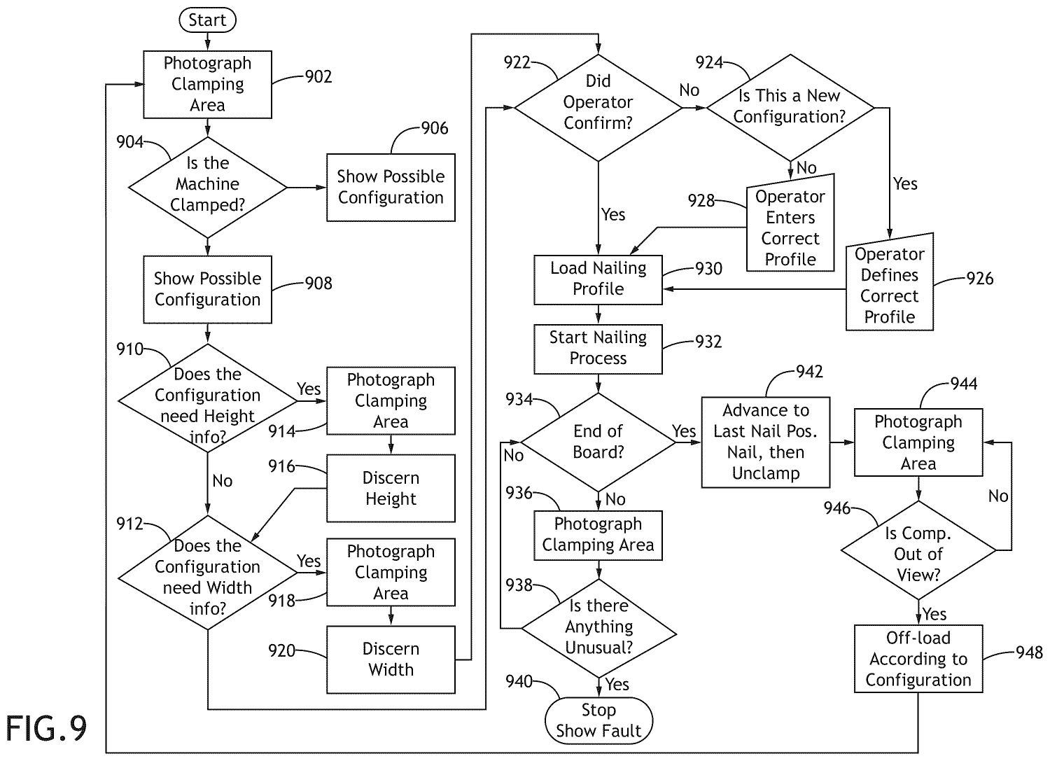

Referring now to FIGS. 8-9, flow diagrams for automated assembly, in accordance with one or more embodiments of the present disclosure.

FIG. 8 illustrates a flow diagram of a method 800 for automated assembly, in accordance with one or more embodiments of the present disclosure. The embodiments and enabling technologies described previously herein in the context of the automated assembler 100 should be interpreted to extend to the method 800. It is further noted, however, that the method 800 is not limited to the architecture of the automated assembler 100.

In some embodiments, the method 800 includes a step 802 of providing two or more pieces of input lumber 104 (e.g., to an assembly sub-system 102). For example, two or more pieces of input lumber 104 may be provided on an input feeder 108 of the automated assembler 100 in an orientation suitable for fastening into an assembled product 106.

In some embodiments, the method 800 includes a step 804 of selecting a profile for fastening the input lumber 104 to form an assembled product 106. For example, the step 804 may include selecting or determining a type of assembled product 106 to be fabricated from the input lumber 104 (e.g., an el, a header, a double el, or any other combination of input lumber 104 forming an assembled product 106) and further determining a profile for fastening the input lumber 104 to form the assembled product 106. As an illustration, the profile may include a number and/or arrangement of fastening locations (e.g., locations at which to the input lumber 104 are to be fastened to form the assembled product 106). As another illustration, the profile may include a type of fastener associated with each fastening location (e.g., a nail, a screw, a bolt/nut, glue, or the like). As another illustration, the profile may include various processing steps associated with any of the fastening locations. For example, the profile may include instructions to drill pilot holes at one or more fastening locations. In a general sense, the profile may include any information or instructions required to assemble the input lumber 104 into the selected assembled product 106.

The profile may be selected in step 804 using various techniques.

In some embodiments, the step 804 includes receiving the profile from a user. For example, the user may manually provide the profile (e.g., by transferring one or more files to the automated assembler 100). As another example, the automated assembler 100 may prompt the user to select or create the profile via a user interface 120.

In some embodiments, the step 804 includes predicting the profile based on sensor data generated by one or more sensors 138 on the automated assembler 100. For example, the sensor data may correspond to image data of the input lumber 104 from one or more angles. As another example, the sensor data may correspond to line sensor data such as, but not limited to, height data from a line sensor as depicted in FIG. 4.

In a general sense, the sensor data may include any data indicative of a number or orientation of input lumber 104 provided to the automated assembler 100.

In some embodiments, the step 804 includes identifying two or more pieces of input lumber 104 based on the sensor data, where the identification includes at least one of a number or orientation of the two or more pieces of input lumber 104. The step 804 may then include determining (e.g., predicting) the profile based on the identification. As an illustration, the sensor data may be used to determine a type of assembled product 106 based on the number and/or orientation of the input lumber 104 and select a corresponding profile for that type of assembled product 106.

Further, the profile may be determined based on sensor data using a variety of techniques. In some embodiments, the profile (and/or the type of assembled product 106, which may dictate the profile) may be determined based on pre-programmed logical analysis of the sensor data. For example, the various types of assembled products 106 shown in FIG. 7 may be distinguished based on characteristics determinable by sensor data such as, but not limited to, a number of pieces of input lumber 104, a combined width of the input lumber 104, or a height profile of the various pieces of input lumber 104. In this way, various thresholding techniques may be used to identify or select the appropriate type of assembled product 106 and an associated profile for fabricating this assembled product 106. As an illustration, a tee 712 and a double el 714 may have the same total width, but may be distinguished based on the height profile (e.g., a double el 714 may have a single height step change, whereas the tee may have two height step changes). It is contemplated that numerous such thresholding techniques may be pre-programmed to distinguish between any number of types of assembled products 106) such that the scope of the present disclosure is not limited to any single technique.

In some embodiments, the profile (and/or the type of assembled product 106, which may dictate the profile) may be determined based on machine learning. For example, a machine learning may be trained (e.g., with supervised learning, semi-supervised learning, reinforcement learning, or any other suitable technique) with training data that includes sensor data associated with known types of assembled products 106 and/or known profiles. In this way, patterns or thresholds that distinguish the various types of assembled products 106 do not need to be explicitly programmed. Rather, the machine learning model may generate associations between various aspects of the sensor data through the training process such that the machine learning model may identify the type of assembled product 106 and/or the suitable profile for fastening the input lumber 104.

In some embodiments, the method 800 includes a step 806 of fastening the two or more pieces of input lumber 104 with the one or more fastening tools 134 using the profile to form the assembled product 106. In this way, the automated assembler 100 may fabricate an assembled product 106 with input lumber 104 provided in step 802 based on the fastening profile determined in step 804.

Referring now to FIG. 9, FIG. 9 illustrates a flow diagram depicting one implementation of the method 800, in accordance with one or more embodiments of the present disclosure. In particular, steps 902-924 may correspond to step 804 of the method associated with selecting a profile (e.g., a fastening profile) for fabricating an assembled product 106 from input lumber 104 and steps 932-948 may correspond to step 806 of the method associated with fastening the two or more pieces of input lumber with the one or more fastening tools using the profile to form the assembled product.

In some embodiments, the automated assembler 100 may photograph a clamping area (box 902) with a sensor 138 (e.g., with a camera sensor 138) and determine whether input lumber 104 is clamped (box 904) and show possible configurations to an operator (e.g. a user) (box 906 and/or box 908) for verification. Further, the automated assembler 100 may determine whether the particular configuration requires height and/or width information for the input lumber 104 (box 910 and/or box 912). If so, the automated assembler 100 may determine the height and/or width based on one or more images of the clamping area (boxes 914, 916, 918, 920).

The automated assembler 100 may then prompt an operator to confirm the configuration (e.g., confirm the type of assembled product 106 and/or the profile for fastening the input lumber 104 to form an assembled product 106). At this point, the operator may accept the profile, correct the profile, or define a new profile.

Once it is determined whether the operator has confirmed (box 922) the configuration, the automated assembler 100 may then fasten the input lumber 104 according to an associated fastening profile (e.g., may fasten any combination of the input lumber 104 at any locations along the height or width of the input lumber 104) to form the desired assembled product 106.

For example, if the operator does not confirm the configuration, different actions may be taken depending on whether the present configuration is new or not (box 924). If it is new, then the operator may define a profile for this configuration (box 926). If it is not new, the operator may simply enter the correct profile for the configuration (box 928).

Once the proper profile is determined, this profile may be loaded (box 930) and started (box 932).

FIG. 9 further depicts a process in which the step 806 incorporates an end of board sensor 138 to trigger final fastening and analysis of the assembled product 106. Any type of end of board sensor may be used including, but not limited to, a line sensor (e.g., as depicted in FIG. 4) or an image coupled with image analysis.

The automated assembler 100 may then identify an end of board (box 934),

The automated assembler 100 may further provide anomaly analysis at any point of the process (e.g., using one or more machine learning models). In this way, the automated assembler 100 may identify any issues and either take corrective action or pause fastening and alert the user. For example, FIG. 9 depicts periodically photographing the clamping area including the input lumber 104 (box 936) and determining whether anomalies are present (box 938). If an anomaly is detected, the process may be stopped (box 940) and for analysis by the operator. Any detected faults may also be shown.

Once the end of board sensor 138 identifies an end point of the input lumber 104, any final fasteners may be applied and the resulting assembled product 106 may be unclamped (box 942). The assembled product 106 may then be moved from the assembly sub-system 102 (e.g., as verified through imaging in box 944 and box 946) and offloaded (box 948) to an output feeder 110. In the case of an output feeder 110 with multiple stages, the assembled product 106 may be sorted to an assigned stage based on any selected criteria.

For instance, it is contemplated that the assembled product 106 may be removed to multiple short-term staging areas. Each destination may be linked with the learned program of the controller and executed automatically. If the operator may desire to assemble an assembled product 106 not previously loaded in the memory 118, he/she may create a new classification in the system and specify where it is to be nailed and finally where it is to be delivered upon completion. The user may arrange the material specific to this new classification (e.g., profile) and direct the controller 114 to learn the new classification. After several iterations, the controller may be configured to reliably identify this new subcomponent.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An automated assembler, comprising:
an input feeder;
an assembly sub-system configured to receive two or more pieces of input lumber from the input feeder, wherein the assembly sub-system comprises:
one or more sensors configured to generate sensor data associated with at least one of positions or orientations of the two or more pieces of the input lumber;
one or more guides configured to position at least some of the two or more pieces of the input lumber in a selected orientation based on data from the one or more sensors; and
one or more fastening tools configured to fasten the two or more pieces of the input lumber to form an assembled product; and
one or more output feeder configured to receive the assembled product.

2. The automated assembler of claim 1, further comprising:
a controller including one or more processors configured to execute program instructions stored on a memory device, wherein the program instructions are configured to cause the one or more processors to:
identify the two or more pieces of the input lumber based on the sensor data;
determine a profile for forming the assembled product based on the identification of the two or more pieces of the input lumber; and
direct the one or more guides and the one or more fastening tools to form the assembled product according to the profile.

3. The automated assembler of claim 2, wherein identify the two or more pieces of the input lumber based on the sensor data comprises:
identify the two or more pieces of the input lumber based on the sensor data using a machine learning model.

4. The automated assembler of claim 3, wherein the machine learning model is trained with training data using at least one of a supervised technique or a semi-supervised technique, wherein the training data includes training sensor data associated with known training components.

5. The automated assembler of claim 1, wherein at least one of the one or more sensors comprises:
a line sensor.

6. The automated assembler of claim 1, wherein at least one of the one or more sensors comprises:
a camera.

7. The automated assembler of claim 1, wherein at least one of the one or more guides comprises:
a stop.

8. The automated assembler of claim 1, wherein at least one of the one or more guides comprises:
one or more vertical rollers.

9. The automated assembler of claim 1, wherein at least one of the one or more guides comprises:
one or more horizontal rollers.

10. The automated assembler of claim 1, wherein at least one of the one or more fastening tools comprises:
one or more nail guns.

11. A method for automated assembly, comprising:
providing two or more pieces of input lumber to an assembly sub-system, wherein the assembly sub-system comprises:
one or more sensors configured to generate sensor data associated with at least one of positions or orientations of the two or more pieces of the input lumber;
one or more guides configured to position at least some of the two or more pieces of the input lumber in a selected orientation based on the sensor data from the one or more sensors; and
one or more fastening tools configured to fasten the two or more pieces of the input lumber;
selecting a profile for fastening the input lumber to form an assembled product; and
fastening the two or more pieces of the input lumber with the one or more fastening tools using the profile to form the assembled product.

12. The method of claim 11, wherein selecting a profile for fastening the assembled product comprises:
receiving a selected profile from a user.

13. The method of claim 11, wherein selecting the profile for fastening the assembled product comprises:
predicting the profile based on the sensor data.

14. The method of claim 13, wherein predicting the profile based on the sensor data comprises:
identifying the two or more pieces of the input lumber based on the sensor data; and
determining the profile based on the identification of the two or more pieces of the input lumber.

15. The method of claim 13, wherein identifying the two or more pieces of the input lumber based on the sensor data comprises:
identifying the two or more pieces of the input lumber based on the sensor data using a machine learning model.

16. The method of claim 15, wherein the machine learning model is trained with training data using at least one of a supervised technique or a semi-supervised technique, wherein the training data includes training sensor data associated with known training components.

17. The method of claim 11, wherein at least one of the one or more sensors comprises:
at least one of a line sensor or a camera.

18. The method of claim 11, wherein the one or more guides comprise:
at least one or more vertical rollers or one or more horizontal rollers.

19. The method of claim 11, wherein at least one of the one or more fastening tools comprises:
one or more nail guns.

20. The method of claim 11, further comprising:
securing the two or more pieces of the input lumber with the one or more guides based on the profile prior to fastening the two or more pieces of the input lumber with the one or more fastening tools to form the assembled product.
